(19) United States
(12) Patent Application Publication
(10) Pub. No.: US 2024/0318005 A1
(43) Pub. Date: Sep. 26, 2024

(54) NANO-FUNCTIONALISED CLAY MINERALS FOR STRUCTURAL COLOURATION

(71) Applicant: Jon Otto FOSSUM, Trondheim (NO)

(72) Inventors: Josef BREU, Bayreuth (DE); Jon Otto FOSSUM, Trondheim (NO); Volodymyr DUDKO, Bayreuth (DE); Paulo BRITO, Trondheim (NO)

(21) Appl. No.: 18/577,609

(22) PCT Filed: Jul. 8, 2022
(86) PCT No.: PCT/EP2022/069194

§ 371 Date: Jan. 8, 2024

(30) Foreign Application Priority Data
Jul. 8, 2021 (GB) 2109863.7

(51) Int. Cl. C09C 1/42; C08J 3/075; C08J 3/21; C08K 9/02; C09C 3/00; C09C 3/04; C09C 3/06; C09D 7/40; C09D 7/62; C09D 17/00

(52) U.S. Cl. CPC C09C 1/42; C08J 3/075; C08J 3/212; C08K 9/02; C09C 3/006; C09C 3/04; C09C 3/06; C09D 7/62; C09D 7/70; C09D 17/001; C09D 17/004; C01P 2002/20; C01P 2004/20; C08J 2301/08; C08J 2335/02; C08J 2389/06

(57) ABSTRACT

A process for producing structural colours from smectite or vermiculite clay mineral comprising: (i) intercalating cations in every second layer of said clay mineral; and (ii) dispersion of the intercalated clay mineral in water to form an aqueous suspension.

This invention relates to the use of clay minerals for structural colouration. In particular, we require that certain synthetic or natural clay minerals are intercalated with cations in every second layer and delaminated as bilayers and dispersed in water, hydrogel or polymer matrix. The resulting suspension, hydrogel or polymer matrix can be converted into bright non-iridescent photonic (UV-VIS-NIR-IR) films/pigments with controllable layer spacings giving reflective intensity enhancement at corresponding wavelengths. The use of smectite such as synthetic or natural hectorite, or natural vermiculite clay minerals is especially preferred.

### BACKGROUND OF INVENTION

Structural colouration is the main way in which colour is produced in nature. Structural colouration observed in animals, insects and plants results from constructive interference of light reflected from structured semi-transparent nanostructured materials. One typical length-scale between light reflecting interfaces inside the surface of the nanostructured material matches one wavelength of the incoming white light, thus giving constructive interference and enhancement of the intensity of the reflected light at that particular wavelength according to Bragg-Snell's law.

Bright natural examples are peacock feathers, butterfly wings, or the remarkable chameleon that can change its bright color rapidly by stretching its skin, and in doing so changes distances between nanoparticles in the skin, thus changing distances between interfaces that each reflect light, giving rise to the type of color selection described above.

Most industrial pigments and dyes use chemical colouration. A disadvantage of chemical colouration is that the pigments are often toxic and easily fade over time or upon exposure to light. As structural colouration is mostly material independent, pigments using structural colouration can be realised using non-toxic sustainable materials with no risk of fading. The ability to produce structural colour from inherently near colourless materials has attracted considerable research interest.

Despite structural colouration being of significant interest, it is not implemented in a wide range of applications. One reason for this is the time scale it takes to develop and produce pigments using this concept. Another reason is the requirement to identify suitable sustainable low-cost materials.

An important factor for natural structural colouration, as well as for potential industrial applications, is the degree of iridescence. Material surfaces that provide non-iridescent colour are difficult to achieve using structural colouration. Non-iridescent materials are favoured as their colour is not dependent on the angle of incident or scattered light.

Clay minerals are of significant interest for upscalable applications, due to the fact that they are sustainable materials in terms of natural abundance, their stability over geological timescales and their non-toxic properties. Despite this, structural colours have not yet been realized based on clay minerals.

Smectite and vermiculite clay minerals are made up of two-dimensional nanolayered stacked particles consisting of tetrahedral and octahedral sheets. These are organized in a 2:1 layered structure where each layer is made up of one of the octahedral type sheets sandwiched between two tetrahedral type sheets. Depending on the composition of the sheets, the composed layer has a net negative charge. The charge is neutralized by an interlayer cation.

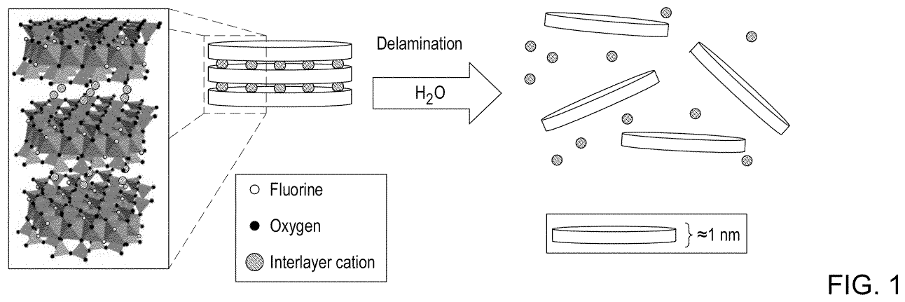

Clay nanolayers can spontaneously delaminate in aqueous solutions resulting in an aqueous dispersion of single clay nanolayers. This is displayed in FIG. 1. Single clay nanolayers are however, almost transparent in the visible range and reflect very little light. Single clay nanolayer suspensions do not therefore produce bright colours.

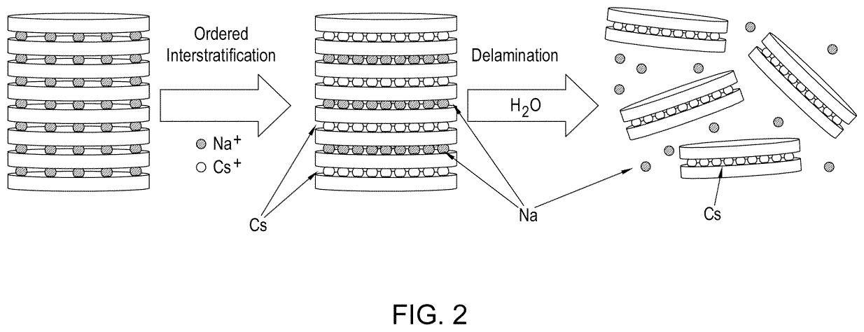

Ordered interstratification of the clay, whereby the cations in every other layer are replaced, can produce aqueous suspensions of double layer platelets comprised of two single layers with a cation intercalated in between the two single layers. This is displayed in FIG. 2. Such layered silicates with alternating cations are known and described by Stöter et al (Controlled Exfoliation of Layered Silicate Heterostructures into Bilayers and Their Conversion into Giant Janus Platelets. Angewandte Chemie International Edition 55, 7398-7402, doi: 10.1002/anie.201601611 (2016)).

The present inventors have now found that aqueous suspensions of double layer platelets derived from clays such as fluorohectorite can provide bright and non-iridescent structural colours that can easily be tuned by controlling parameters such as concentration, salinity and matrix gelation. The photonic system is rapidly produced from low cost and sustainable materials. Due to the sustainability and abundance of clay minerals, this system carries considerable potential for up-scaled applications in various areas ranging from cosmetics and health, paint pigments for various applications and windows and tiles.

### SUMMARY OF INVENTION

The present invention relates to a process for producing structural colours from a smectite, or vermiculite clay mineral comprising:
(i) intercalating cations in every second layer of said clay mineral; and
(ii) dispersion of the intercalated clay mineral in water to form an aqueous suspension.

Viewed from another aspect the invention provides a process for producing structural colours from smectite or vermiculite clay mineral comprising:
(i) intercalating caesium (Cs), rubidium (Rb), barium (Ba), or strontium (Sr) cations in every second layer of said clay mineral; and
(ii) dispersion of the intercalated clay mineral in water to form an aqueous suspension.

Viewed from another aspect the invention provides a process for producing structural colours from smectite, or vermiculite clay mineral comprising:
(i) intercalating cations in every second layer of said clay mineral;
(ii) dispersion of the intercalated clay mineral in water to form an aqueous suspension;
(iii) fixing the aqueous suspension, e.g. in a hydrogel or polymeric matrix; and optionally
(iv) enhancing the colour of the fixed aqueous suspension, e.g. hydrogel or polymeric matrix, by absorbing white light, e.g. through the use of a dark background or by forming a colloid by adding dark particles such as carbon black or iron oxide thereto.

Dispersion of the intercalated clay mineral in an aqueous suspension allows the formation of double layer platelets in the dispersion in which the intercalated cation is between the two layers. In further embodiments, the invention provides an aqueous suspension of double layer smectite or vermiculite platelets with a cation between the layers, wherein the platelets are present in the aqueous suspension in about 0.3 (v/v) % to about 8.0 (v/v) %.

Viewed from another aspect the invention provides a hydrogel or polymeric matrix comprising double layer smectite or vermiculite platelets with a cation intercalated between the layers, wherein the platelets are present in the hydrogel in about 0.3 (v/v) % to about 8.0 (v/v) %.

Viewed from another aspect the invention provides use of double layer intercalated smectite or vermiculite clay platelets with a cation intercalated between the layers for providing structural colour.

Viewed from another aspect the invention provides an apparatus comprising a light absorbing background and an aqueous suspension, hydrogel or polymeric matrix comprising double layer smectite or vermiculite platelets with a cation intercalated between the layers. In one embodiment, the aqueous suspension, hydrogel or polymeric matrix further comprises embedded dark particles.

Viewed from another aspect the invention provides a non-iridescent coating comprising:
(i) double layer smectite or vermiculite platelets with a cation intercalated between the layers; and
(ii) a binder.

### DETAILED DESCRIPTION OF THE INVENTION

The invention primarily relates to a process for producing structural colours from smectite or vermiculite clay in which the cations in every other layer of the smectite or vermiculite clay have been replaced to provide an ordered interstratified heterostructure. It will be appreciated that the cation used must be different from the naturally occurring cation in the clay, e.g. not Na. The use of smectites such as hectorite, fluorohectorite, or vermiculite clays is preferred.

Fluorohectorite is specific member of the smectite family. It is the smectite clay with the largest aspect ratio and the most preferred option herein.

Vermiculite is considered a separate clay from smectites although the structure of the smectite and vermiculite clay minerals is very similar. They are divided into two families as the net charge that each clay platelet is carrying, i.e. the charge that is compensated by the interlayer cations (Na+, Cs+ etc), is larger for the vermiculites than for the smectites.

Vermiculites have a large aspect ratio and can therefore be expected to provide colour like fluorohectorite.

The clay heterostructures are dispersed in water to produce a suspension of double layer platelets comprising two single clay layers with the newly introduced cations intercalated in between the two single layers (see FIG. 2). Such an aqueous dispersion (or suspension—these terms are used interchangeably herein) can act as a structural colour source. No one before has appreciated that these platelets can be used as a non-iridescent structural colour source.

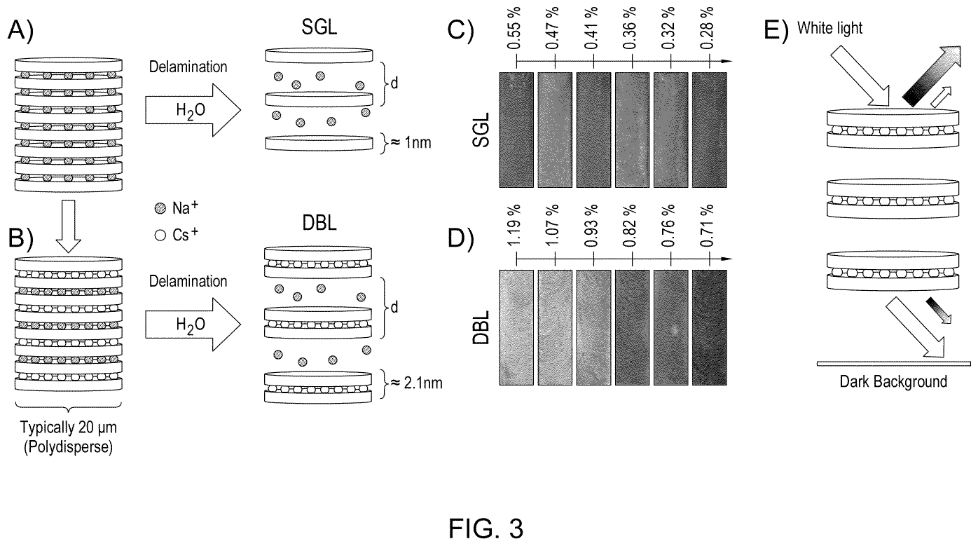

To maximise the colour, it is preferred if the light that is transmitted through the aqueous suspension is absorbed by a dark substrate or embedded dark particles to prevent the reflection of white light that will fade the brightness of the structurally enhanced colour (see FIG. 3).

The principle of reflective structural coloration obtained from a lamellar Bragg-stack suspension corresponding to a colloidal platelet smectic liquid crystalline phase occurs when the lamellar distances match the wavelength of the incoming white light. The interference of the reflected white light from all layers and the effect of the refractive index included in the Bragg-Snell's equation

$$2 {d ( {n}^{2} - {sin}^{2} θ )}^{1 / 2} = m λ ,$$

where d is the lamellar distance, θ is the angle between the observer's point of view and the lamella horizontal, n is the effective refractive index, in the present case a weighted combination of the water the refractive index and the clay lamella refractive index, m is the order of the Bragg-Snell reflection and λ is the wavelength of the light enhanced by constructive interference for a given d and θ. The effect of the refractive indices modifies the light paths according to the Bragg-Snell's law.

The scheme above shows the principle of reflective structural coloration obtained from a lamellar Bragg-stack suspension. It shows how the refractive index modifies the light paths described by the Bragg-Snell Law, where the effective refractive index n is a weighted combination of n₁ and n₂.

### Clay

The clay mineral that is used to produce the structural colours is a smectite or vermiculite clay, preferably a smectite such as fluorohectorite, e.g. synthetic fluorohectorite, or vermiculite, e.g. natural vermiculite clay. These clay minerals are layered and contain cations in between the layers. The layers of the clay minerals are organised in a 2:1 layered structure wherein each layer comprises an octahedral type sheet sandwiched between two tetrahedral type sheets.

The smectite and vermiculite clay minerals that act as the starting material often comprise sodium ions between the layers. In order to be suitable for producing structural colours, the cations in every other layer of the clay mineral are exchanged to provide an ordered interstratified heterostructure. Such a process is known as ordered-interstratification followed by delamination. Here this includes partial ion exchange of sodium or lithium cations with, inter alia, caesium (Cs), rubidium (Rb), barium (Ba), or strontium (Sr) cations.

Suitable cations include alkali and alkaline earth metals, preferably Cs, Ba, Rb and Sr, especially Cs. Suitable cations also include charged molecules such as ammonium ions or charged nanoparticles such as iron oxide. This is depicted in FIG. 2.

When suspended in water, the interstratified heterostructures with intercalated cations delaminate to form suspended double layer platelets comprising two single layers with the intercalated cation between them. The double layer platelets are approximately 2 nm thick. The structurally modified clay suspended in water provides a semi-transparent material which reflects part of incoming white light. It is reflected white light from all the layers that interfere constructively according to Bragg-Snell's law that gives enhancement of a single colour. The constructive interference of white light from individual nanosheets is defined by the Bragg-Snell's law, 2d(n²−sin²θ)^{1/2}=mλ, where d is the nanosheet separation, θ is the angle between the observer's point of view and the nanosheet plane, n is an effective refractive index, which is a weighted combination of the refractive indices of the nanosheets and the solvent, m is the order of the Bragg-Snell reflection and A is the wavelength of the light enhanced by constructive interference.

The platelets are polydisperse with an average diameter of about 5 to about 20 μm. The individual platelets are about 1 to about 100 μm in diameter.

This aqueous suspension is therefore a structural colour source.

The aqueous suspension may contain other solvents, however the aqueous suspension preferably consists of water as the solvent.

The aqueous suspension may contain salts, such as sodium chloride. The salt concentration in the aqueous suspension is from about 1×10⁻⁶ M to about 1.0 M, preferably from about 1×10⁻⁵ M to about 1×10⁻³ M.

The clay mineral is present in the aqueous suspension from about 0.3 (v/v) % to about 8.0 (v/v) %, preferably from about 0.3 (v/v) % to about 2.0 (v/v) %, especially from about 0.3 (v/v) % to about 1.4 (v/v) %. Higher concentrations tend to produce blue colours whereas lower concentrations tends to produce red colours.

The achievement of a red color is challenging in structural coloration, both for scientific reasons, and due to upscaling issues. The present invention solves this issues. In particular, the achievement of the red colour occurs in an invention that can be readily upscaled.

The platelet-platelet interlayer distance determines the wavelength enhanced from the structure. The platelet-platelet interlayer distance can be easily tuned and thus the wavelength enhanced from the aqueous suspension is easily modified (See FIG. 3). Furthermore, the enhanced wavelength is easily predictable. The distance between the platelets is affected by the concentration of the clay and therefore by changing the concentration of the clay, the colour can be changed. The distance between the platelets is also affected by the salt concentration of the aqueous suspension. The salinity of the water therefore provides an additional parameter that controls the photonics of the system. This means the colour of the system may simply be manipulated by changing the salt concentration. The colour is also dependent on the temperature and pH of the aqueous suspension. It may be therefore that a buffer is used to maintain a desired pH and hence desired colour.

The resulting structural colour is non-iridescent meaning the reflected colour is not dependent on the angle of incidence or angle of observation with respect to the surface. Without wishing to be bound by theory, the non-iridescent property results from disorder in the orientation of nematic organization which may come from turbostratic organization and the large lateral area of the platelets which mean they may curve and undulate. Non-iridescence has practical use in film/pigment colouration.

We are the first to identify such an aqueous suspension as a structural colour source. However, the use of an aqueous suspension as a structural colour source has limited interest as the suspension requires a vessel to contain it. Fixation is therefore important for application of the photonic clay structures. By fixation is meant conversion of the aqueous suspension into a solid form, e.g. a solid film.

There are several established protocols for solidification of particles in aqueous suspension, including for clay systems. In one embodiment, sol-gel or silanization protocols can be used as a fixing agent.

The photonic clay structures may be fixed in a hydrogel. Fixation of the structures in hydrogels is important for pigment fabrication and applications in creams and paints. Hydrogel films can also provide subsequent change of colour by compression. Hydrogel films can be produced by adding a polyethylene glycol derivative, for example poly(ethylene glycol) diacrylate, and a photoinitiator, for example lithiumphenyl-2,4,6-trimethyl-benzoyl phosphinate, to an aqueous suspension of the double layer platelets. UV light is then used to polymerise the hydrogel.

The clay structures may be fixed in a polymeric matrix therefore. The skilled person can devise ways of fixing the aqueous suspension. It will be appreciated that maintaining transparency during fixing is important.

The initial suspension of platelets appear to be stable on the timescale of days, which is sufficient for practical fixation.

Fixation allows the formation of thin films of the aqueous suspension e.g. having a thickness below 1 mm.

A challenge when fixing the clay is to keep the clay periodicity for tuned solid-state colours. Direct polymerization of monomers during fixation may result in change in the periodicity of the clay layer distances.

To resolve this as a first alternative route, suitable monomers could be utilized directly as the solvent to disperse the clay, which could be polymerized after the structural color has been established.

As a second alternative route, bio-sourced polymers (cellulose derivatives, gelatine, etc.) could be explored as the matrix for fixation for sustainability and environmental compatibility.

As a third alternative route one could use a two-step method employing interpenetrating networks based on biobased agarose combined with common hydrogel monomers. In this case, the first network could be formed by gelation of the agarose, thus temporarily fixing the clay structure. Subsequently, hydrogel monomers could be introduced into the composite, which could form the second the network by polymerization. This would permanently fix the structural color, and the agarose network from the first step could be removed by washing. Different types of agarose and hydrogel monomers could be investigated in this way to achieve the optimal fixation and optical clarity, while at the same time taking the application scenario (pigment shelf-life, biocompatibility etc.) into consideration.

As a fourth alternative route one could use an acrylic type copolymer or resin or alkyd type resin, water or other solvent soluble type resins as a matrix for fixation of the clay structures after the polymerization.

Once clays are fixed in a hydrogel composite, polymeric matrix or the like, a suitable method must be employed to dehydrate the gel for pigments applications. By utilizing lyophilization techniques to dehydrate the composite without inducing significant volume changes, the sample could first be frozen in liquid nitrogen and the water could be sublimated under high vacuum. In this way, the volume of the composite would be optimally preserved and thus also the structural color. In case the lyophilization induces turbidity in the gel due to crystallization of water, other techniques such as critical point drying could be utilized, and the parameters could be optimized for the specific system.

Subsequently to fixation, the dehydrated composites described above (e.g. the four alternative routes) could be ground by a ball mill to produce coloured pigments in powder form.

Application of photonic clay structures preferably requires the use of a light absorbing substrate to prevent the reflection of white light that will fade the brightness of the structurally enhanced colour. One option is the use of a light absorbing background beneath the photonic clay structures.

In some applications the light absorbing mechanism may be embedded in the dispersion, for example black additives such as carbon black. Such a system may be a colloid. A preferred option therefore involves a colloidal dispersion of carbon black in an aqueous suspension or fixation matrix in which the platelets of the invention are present.

### Absorption of White Light:

Methods of attenuating white light scattering to enhance the structural colour brilliance in the system are therefore important. A dark background can be initially used to absorb white light, while more sophisticated techniques could be explored such as embedding carbon black particles in the polymeric network.

One further option is the use of dark backgrounds that are reflective or emissive in the infra-red spectrum for radiative cooling.

The photonic clay system can be used in a wide variety of applications. For example in windows, tiles or coatings, and pigments in paints, textiles or cosmetics. The ability to tune the distance between the platelets means colours in the whole UV-VIS-IR range may be accessed.

When incorporated into a paint, the photonic clay system of the invention may further comprise standard paint components, e.g. a binder.

The invention is now described with reference to the following non limiting examples and figures.

FIG. 1: Schematic of the 2D lamellar structure of the synthetic fluorohectorite (FHt) clay mineral. The octahedral sites contain magnesium partially substituted by lithium. The octahedral sheet is sandwiched in between the tetrahedral sheets. The interlayer cations are typically Na⁺ from the synthesis. Na-FHt spontaneously can delaminate in water into single 1 nm thick layers that subsequently can self-organize into nematic phases.

FIG. 2: Schematics of the protocol for production of suspended FHt double layers (DBLs). The protocol includes a first step of ordered interstratification in the clay stacks, replacing the sodium cations by another cation (in the present case caesium) in every second interlayer, and a second step of delamination into DBLs.

FIG. 3: Part A, Schematic of protocol for delamination of FHt into single layers (SLGs). Part B, Schematics of the protocol for production of suspended FHt double layers (DBLs). The protocol includes a first step of ordered interstratification in the clay stacks, replacing the sodium cations by another cation (in the present case cesium) in every second interlayer, and a second step of delamination into double layers. Parts C (SGLs) and D (DBLs) then show the differences between the colour produced at various concentrations (vol %) of the platelets in water. In contrast, colours obtained using a single layer material are shown in part C. Colours are much more vivid in part D). Part E shows the principle of a dark background to prevent light reflection. Each lamella is semi-transparent thus reflecting part of the incoming white light, and it is reflected white light from all the layers that interfere constructively according to Bragg-Snell's law thus giving enhancement of a single colour that is dependent on the layer distance. The white light that is transmitted through the whole stack is absorbed by a dark background.

We demonstrate that by tuning the Na-FHt/water ratio, nanosheet separations corresponding to the wavelength range of visible light, photonic Bragg-stacks covering the whole spectrum of rainbow colours can be produced easily and rapidly. Structural colours produced from suspended SGLs, gave colours of mediocre brightness (FIG. 3C)). However, brightness and non-iridescence of the structural colours of the clay photonic structures can be improved enormously by applying double layers (DBL) pinned together by Cs (FIG. 3D).

### EXAMPLES

### Materials

Sodium fluorohectorite (Na-FHt) ([Na_{0.5}]^{inter}[Mg_{2.5}Li_{0.5}]^{oct}[Si₄]^{tet}O₁₀F₂) was obtained by melt synthesis followed by long-term annealing. The material featured a cation exchange capacity (CEC) of 1.27 mmol per g, density 2.73 g/cm³.

CsCl ReagentPlus®, ≥99.9% purchased from Sigma Aldrich for the ordered interstratification.

NaCl EMSURE® ACS, ISO, reag. Ph. Eur, purchased from Sigma Aldrich was used to control DBL distances and thus the structural colours.

Poly(ethylene glycol) diacrylate (PEG-DA), Mₙ=575 g/mol, and Lithiumphenyl-2,4,6-trimethyl-benzoyl phosphinate (LPh), ≥95% purchased from Sigma Aldrich was used to fix photonic clays structures in a hydrogel.

### Sample Preparation

In the following, the clay concentrations are expressed as volume fraction in units of percentage (Φ). Before the natural vermiculite clay can be used in the same way as the synthetic case, the vermiculite needs to be charged reduced following well established and published protocols.

Na-FHt single layers (SGLs) stock suspensions (SGS) at Φ=0.72% were produced by spontaneous exfoliation in water governed by repulsive osmotic swelling of sodium interlayers.

The Cs-FHt double layers (DBLs) were obtained by ordered interstratification following the protocol described by Breu et al, Stöter, M.; Godrich, S.; Feicht, P.; Rosenfeldt, S.; Thurn, H.; Neubauer, J. W.; Seuss, M.; Lindner, P.; Kalo, H.; Möller, M.; Fery, A.; Förster, S.; Papastavrou, G.; Breu, J. Controlled Exfoliation of Layered Silicate Heterostructures into Bilayers and Their Conversion into Giant Janus Platelets. Angew. Chem., Int. Ed. 2016, 55, 7398-7402, DOI: 10.1002/anie.201601611) which constitutes a partial ion-exchange of interlayer sodium cation with caesium resulting in an ordered interstratified heterostructure. When dispersed in water the sodium interlayer undergoes repulsive osmotic swelling resulting in DBL suspensions.

DBL stock suspension (DS) at Φ=1.34% was produced by centrifugation. Subsequently suspensions of varying concentrations (1.26-0.56%) were prepared using 400 μl DS and addition of deionized water (25-1100 μl). The SGL suspensions were prepared in varying concentrations (0.64-0.25%) using 400 μl SGS and addition of deionized water (25-700 μl). Then the samples were put in an IKA® overhead shaker at 50 rpm for 30 minutes. Following this the various suspensions were inserted by means of a syringe in Hellma® quartz cuvettes with 1 mm pathlength suitable for spectrophotometer and birefringence measurements.

The SAXS/WAXS samples were prepared from DS by increasing the concentration by centrifugation at 14 rpm with or without overnight silica-controlled drying in a desiccator at room temperature. After this the SAXS/WAXS samples at concentrations 1.340%, 2.561%, 4.287%, 5.563% and 7.210% respectively were inserted in Hilgenberg® glass capillaries with diameter of 1 mm.

Hydrogels were prepared using 400 μL of deionized water, 40 mg of PEG-DA, 0.208 mg of LPh, and 400 μl of DS yielding a hydrogel Ø=0.64%. Hydrogel films approximately 1 mm thick were polymerized at 0-4° C.

The saline solutions were prepared in concentrations from 1×10⁻⁵ to 3×10⁻³ molar using deionized water and from this a series of structural colours were prepared using 400 μL of DS and 350 μL of saline solution yielding a suspension at 0.71 (v/v) %. The samples were put in an IKA® overhead shaker at 50 rpm for 30 minutes and after that inserted by means of a syringe in Hellma® quartz cuvettes with 1 mm pathlength suitable for RSP measurements.

### Methods

Small Angle X-ray Scattering (SAXS) and Wide Angle X-ray Scattering (WAXS): The samples were prepared from DS by increasing the concentration by centrifugation at 14000 rpm to obtain a viscous gel. SAXS/WAXS samples with concentrations of 1.34%, 2.56%, 4.29%, 5.56% and 7.21% respectively were filled in 1 mm glass capillaries (Hilgenberg, code 4007610). SAXS data from DBL suspensions were collected using an X-ray scattering instrument equipped with a Xenocs X-ray micro-source with a copper anode (energy of 8 keV, λ=1.54056 Å) and a Pilatus 3 200k (Dectris) detector positioned at a sample-detector distance approximately 1 meter for SAXS and 20 centimeters for WAXS. The instrument was calibrated with Silver Behenate. The sample was in a glass capillary, with inner diameter of 1 mm. The scattered X-ray intensities have been plotted vs q (Å⁻¹). Background scattering contributions coming from capillary walls, water and instrument atmosphere (helium (SAXS) or air (WAXS)) were subtracted from each measurement.

Reflection Spectrophotometer (RSP): Spectrophotometer (SP) data were collected using an integrating sphere spectrometer Avantes® model AvaSpect-ULS2048Cl-EVO, with available wavelength range 200-1100 nm. The white light source used was Avantes® AvaSphere-50-LS-HAL-12V, with wavelength range 360-2500 nm and colour temperature 2850K. The samples in quartz cuvettes were placed horizontally underneath the integrating sphere on top of a black light-absorbing background.

Images: The same samples in quartz cuvettes used in the RSP measurements were placed horizontally on top of a black background. Images of theses samples were taken using a Canon® EOS 550D camera with objective lens Sigma DC 17-70 mm and a Zeiss® KL 150 LCD light source, colour temperature 3000K.

Birefringence (BF): Birefringence (BF) data were collected by placing the same cuvette samples used for the RSP experiments, vertically in between two crossed polarizers. A Stocker & Yale Imagelite® model 20 light source, colour temperature 3200 K was used and the pictures were taken using a Canon® EOS 550D camera with objective lens EFS 18-55 mm-Magnifying lenses with 180 mm focus were also use in between the crossed polarizers.

Suspensions were made out of Na-FHt SGLs and Cs-FHt DBLs following the protocol discussed above. The DBLs suspensions showed vastly improved brightness compared to the SGL suspensions.

### Effect of Water Salinity

Saline solutions were used to change the ionic strength of the DBL suspension. A red structural colour achieved from DBL suspension at 0.714% was used as reference. The sample preparation procedure was modified by substituting 350 μl of deionised water for 350 μl of NaCl saline solutions (from 1×10⁻⁵ to 3×10⁻³ molar). As a result different structural colours were obtained for the same DBL concentration as the reference sample. The structural colour is blue shifted as the nanosheet separation decreases due to increasing electrostatic screening.

### Non-Iridescent Colours

All the samples discussed above appear non-iridescent to the eye.

### Hydrogel Fixation

Hydrogel films were produced for colour fixation. The platelets were fixed in the gel using the same stock dispersion as for the water dispersions. The hydrogel films also demonstrated colour change upon compression.

1. A process for producing structural colours from smectite or vermiculite clay mineral comprising:
(i) intercalating cations in every second layer of said clay mineral; and
(ii) dispersion of the intercalated clay mineral in water to form an aqueous suspension.

2. The process of claim 1 further comprising
(iii) fixing the aqueous suspension, e.g. in a hydrogel or a polymer matrix

3. The process of claim 1 or 2, wherein the process further comprises:
providing the aqueous suspension or fixed aqueous suspension with a light absorbing background on one side and/or embedding dark particles such carbon black or iron oxide in the aqueous suspension or fixed aqueous suspension.

4. The process of any preceding claim, wherein the intercalated cations are caesium, rubidium, barium and strontium.

5. The process of any preceding claim, wherein the clay mineral is present in the aqueous suspension from about 0.3 (v/v) % to about 8.0 (v/v) %, preferably from about 0.5 (v/v) % to about 3.5 (v/v) %.

6. The process of any preceding claim, wherein the aqueous suspension contains a salt.

7. The process of claim 6, wherein the salt is present in the aqueous suspension from about 1×10⁻⁶ M to about 1 M, preferably from about 1×10⁻⁵ M to about 1×10⁻³ M.

8. The process of any preceding claim, where in the aqueous suspension contains a buffer.

9. The process of any previous claim, wherein the colour of the suspension can be tuned.

10. The process of claims 2 to 9 wherein bio-polymers (cellulose derivatives, gelatine) are used as a matrix for fixation.

11. The process of claims 2 to 9 wherein the hydrogel is lyophilized to dehydrate the hydrogel without inducing significant volume change and optionally the dehydrated material is ground to produce coloured pigments in powder form.

12. The process of claims 2 to 11 wherein the matrix is frozen in liquid nitrogen and the water sublimated under vacuum.

13. The process of claims 2 to 12 comprising:
(i) fixing the aqueous suspension using an acrylic type copolymer or resin or alkyd type resin, or water or other solvent soluble type resin as a matrix for fixation of the clay mineral after the polymerization thereof.

14. A process for producing structural colours from smectite or vermiculite clay mineral comprising:
(i) intercalating cations in every second layer of said clay mineral; and
(ii) dispersion of the intercalated clay mineral in water in the presence of monomers which disperse the clay to form an aqueous suspension;
(iii) polymerizing said monomers after the structural colour has been established.

15. A process for producing structural colours from smectite or vermiculite clay mineral comprising:
(i) intercalating cations in every second layer of said clay mineral; and
(ii) dispersion of the intercalated clay mineral in water in the presence of agarose;
(iii) gelling the agarose, thus temporarily fixing the clay structure; and subsequently introducing hydrogel monomers into the gel and polymerising the same; optionally
(iv) removing the agarose by washing.

16. An aqueous suspension of double layer smectite or vermiculite platelets with a cation intercalated between the layers, wherein the platelets are present in the aqueous suspension in about 0.3 (v/v) % to about 8.0 (v/v) %.

17. A hydrogel comprising double layer smectite or vermiculite platelets with a cation intercalated between the layers, wherein the platelets are present in the hydrogel in about 0.3 (v/v) % to about 8.0 (v/v) %.

18. Use of intercalated smectite or vermiculate clay mineral with a cation intercalated between the layers to provide structural colour.

19. A non-iridescent paint comprising:
(i) double layer smectite or vermiculite platelets with a cation intercalated between the layers; and
(ii) a binder.

20. An apparatus comprising a light absorbing background and an aqueous suspension comprising double layer smectite or vermiculite platelets with a cation intercalated between the layers.
